(19) United States
(12) Patent Application Publication
(10) Pub. No.: US 2008/0026716 A1
(43) Pub. Date: Jan. 31, 2008

(54) Mobile device representing coupons

(75) Inventors: Kristopher C. Billmaier, Kirkland, WA (US); James A. Billmaier, Woodinville, WA (US); David P. Billmaier, Woodinville, WA (US); John M. Kellum, Woodinville, WA (US)

Correspondence Address: FSP LLC, P.O. BOX 890, VANCOUVER, WA, 98666, US

(73) Assignee: Patent Navigation Inc., Woodinville, WA (US)

(21) Appl. No.: 11/811,196

(22) Filed: Jun. 8, 2007

Related U.S. Application Data
(60) Provisional application No. 60/812,368, filed on Jun. 8, 2006.

(51) Int. Cl. H04B 1/16

(52) U.S. Cl. 455/227

(57) ABSTRACT

A method includes a mobile device identifying one or more coupons to point of sale equipment to facilitate the sale of merchandise, and affecting the coupon's value as a result of using the coupon in the sale of merchandise. 1:b:environment for applying a mobile device to coupon transactions 2:f:process of applying a mobile device to coupon transactions

### PRIORITY

The present application claims priority to United States provisional patent application MOBILE DEVICE REPRESENTING COUPONS, having application No. 60/812,368, filed on Thursday, Jun. 8, 2006, which is incorporated herein by reference.

### TECHNICAL FIELD

The present disclosure relates to mobile devices as applied to coupons.

### BACKGROUND

Mobile shoppers frequently encounter transaction situations in which the application of coupons can result in cost savings and/or transaction facilitation. Present techniques for managing such coupons are cumbersome and generally rely on manual location and presentation of the coupons at the point of sale.

### SUMMARY

The following summary is intended to highlight and introduce some aspects of the disclosed embodiments, but not to limit the scope of the claims. Thereafter, a detailed description of illustrated embodiments is presented, which will permit one skilled in the relevant art to make and use various embodiments.

A method may include and/or involve a mobile device identifying one or more coupons to point of sale equipment to facilitate the sale of merchandise, and affecting the coupon's value as a result of using the coupon in the sale of merchandise. The mobile device identifying one or more coupons to point of sale equipment to facilitate the sale of merchandise may include and/or involve the mobile device providing a visual representation of coupon information to the point of sale equipment, and/or one or more of the mobile device or the point of sale equipment invalidating the coupon, and/or one or more of the mobile device or the point of sale equipment debiting value from the coupon, and/or the mobile device communicating wirelessly with the point of sale equipment, and/or the mobile device including one of a cell phone, personal digital assistant, camera, pager, media player, or other handheld device, and/or the mobile device including one of a watch, ring, medallion, jewelry, or other worn item, and/or one or more of the mobile device or point of sale equipment identifying the merchandise to the mobile device, and the mobile device locating applicable stored coupon information, and/or the mobile device providing coupon information to a user of the mobile device and providing for selection by the user. The mobile device providing a visual representation of coupon information to the point of sale equipment may include and/or involve the mobile device presenting an image of at least part of one or more coupons as they would appear in paper form, and/or the mobile device presenting one or more symbols or barcodes, or both, for scanning by the point of sale equipment, and/or the mobile device communicating coupon information to the point of sale equipment, and the point of sale equipment displaying the visual representation of the coupon information, and/or the mobile device facilitating the printing of the coupon information, and/or the mobile device providing a scanned visual image of the coupon information to the point of sale equipment.

The method may include and/or involve the mobile device identifying proximity and/or inclusion within a retail establishment. The mobile device identifying proximity and/or inclusion within a retail establishment may include and/or involve the mobile device applying wireless location recognition capability, and/or the mobile device applying photo recognition to identify one or more brand names, trademarks, or service marks, and/or the mobile device receiving a short-range wireless indication of the identity of the retail establishment from equipment within or proximate to the retail establishment, and/or the mobile device applying user input to identify the proximity and/or inclusion within the retain establishment. The mobile device applying wireless location recognition capability may include and/or involve the mobile device applying one or more of GPS or cellular location technology. The mobile device applying photo recognition to identify one or more may include and/or involve the mobile device applying scanning technology to identify one or more symbols or codes.

The method may include and/or involve the mobile device identifying the merchandise and locating one or more suitable stored coupons. The mobile device identifying the merchandise and locating one or more suitable stored coupons may include and/or involve the mobile device performing photo recognition, scanning of one or more codes or symbols, or a combination thereof, in order to identify the merchandise, and/or the mobile device receiving information about the merchandise wirelessly, and/or the mobile device communicating wirelessly with the point of sale equipment to identify the merchandise, and/or the mobile device receiving the coupon identifications from a cellular network, and/or the mobile device receiving the coupon information and/or merchandise identification from a local wireless network. The mobile device receiving information about the merchandise wirelessly may include and/or involve the mobile device receiving information via one or more of cellular communications, RFID, Bluetooth, Buzzby, Wi-Fi, or Wi-Max.

Other system/method/apparatus aspects are described in the text (e.g., detailed description and claims) and drawings forming the present application.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of an embodiment of a environment for applying a mobile device to coupon transactions.

FIG. 2 is a flow chart of an embodiment of a process of applying a mobile device to coupon transactions.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to influence the operation of a device. Software, hardware, and firmware are examples of logic. Hardware logic may be embodied in circuits. In general, logic may comprise combinations of software, hardware, and/or firmware.

Environment for Applying a Mobile Device to Coupon Transactions

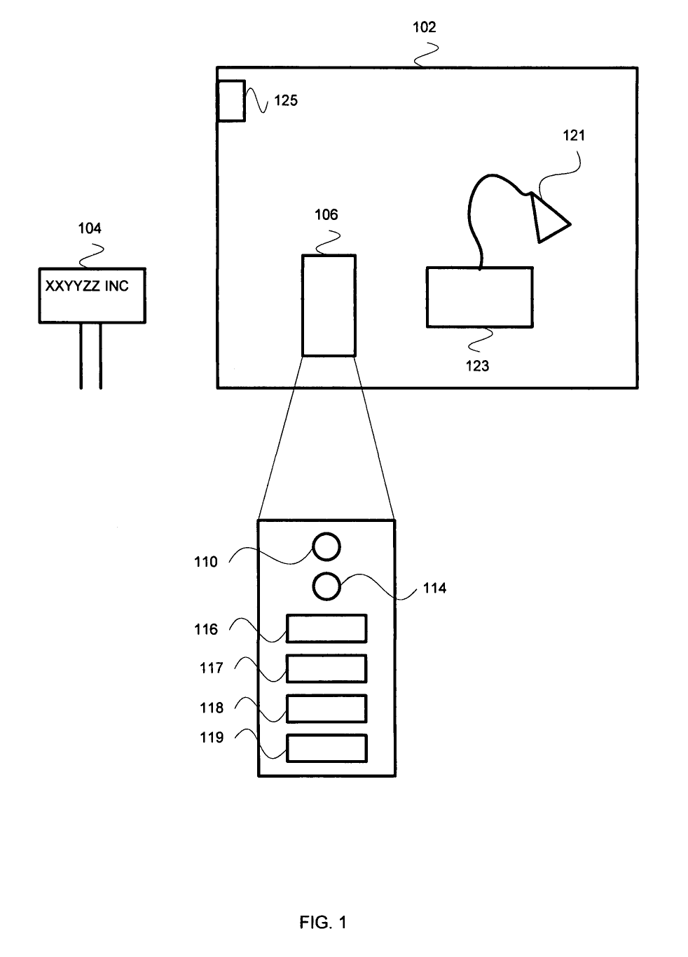

FIG. 1 is a block diagram of an embodiment of an environment for applying a mobile device to coupon transactions.

A building, room, or some other area 102 contains various things. Herein, the building, room, or area 102 will be referred to as the building 102. In this illustration, the building comprises a business or organization location. The building has a sign 104 identifying it (XXYYZZ building or company).

Located within the building 102 there may be an item 125 from which information may be obtained by a mobile device 106. The mobile device 106 may be able to obtain information from the item or items 125 using its own capabilities. For example, the mobile device 106 may have the capability to capture an image of the item 125 and process the image to obtain information from the item or items 125. As a second example, the mobile device 106 and the item 125 may be able to communicate electronically to affect an information exchange.

The information exchanged may include identification of the business or organization or identification of some characteristic of the business or organization. For example, the mobile device 106 may communicate electronically with a device 125 within the building 102 to learn that the location is a retail location for a particular retail chain. Alternatively or additionally, the information obtained may include identification of a manufacturer associated with the item 125. For example, item 125 may be a sign announcing a store display of a particular manufacturer's goods. Either by image recognition or electronically, the mobile device 106 may be able to recognize the manufacturer.

In some embodiments, the mobile device 106 may use information obtained from something located near the building 102, such as the sign 104, to identify the business or organization or some characteristic of the business or organization.

In some embodiments, the mobile device 106 may use location information at least in part to obtain the identifying information about the organization or business. For example, the mobile device 106 may have Global Positioning System (GPS) capabilities that enable it to recognize a position. The mobile device 106 may have the capability to process GPS information either directly or by interacting with some network and/or device to associate a location with a business or organization.

In some embodiments, the mobile device 106 may automatically (meaning with a person not having to take an action to initiate the capability) perform the identification processing upon becoming near or co-located to the item 125 with which it may use to accomplish identification. For example, upon co-location, the mobile device 106 and the item 125 may communicate electronically using Bluetooth, Wi-Fi, RFID, or in some other short or medium range wireless manner. In some cases, a person may have to direct the mobile device 106 to initiate identification logic.

In some embodiments, a person may have to provide some of the identifying information for the business, organization, or manufacturer (herein referred to from this point on as the organization) to the mobile device 106. For example, the device 106 may present a list of candidate organizations to the person using some capability it has, such as a display 117 or speaker. The person may then select the organization. As a second example, the person may type text using a keypad or speak into a microphone of the device 106 to communicate the organization to the device 106. As a third example, a person may select a location on a map which may be presented on the display of the device 106.The particular physical and logical capabilities of the device 106 may determine how the identification of the co-located organization occurs.

The mobile device 106 may comprise various capabilities such as a camera 110 or other scanning or image capture means, a microphone 116, a display 117, a processor and memory 118, and a keypad or keyboard 119. Such capabilities may vary depending on the particular device and not all are illustrated. For example, the device 106 may have a speaker or wireless capabilities. By way of example, the mobile device 106 could be one or more of a cell phone, personal digital assistant, camera, or other handheld device. The mobile device 106 could be a watch, ring, medallion, jewelry, or other worn item.

The environment illustrated may comprise a device 123 which may have scanning capability 121. This device 123 may use its scanning capabilities 121 to obtain information from the mobile device 106. An example of such a device 123 would be a retail checkout (a.k.a. point of sale) scanner. Additionally, in some embodiments this device 123 may have wireless communication capabilities. For example, the device 123 may be able to use its communication capabilities to identify the organization. Also, the device 123 may, when it possesses communication capabilities, obtain information from the mobile device 106 in that manner in addition to or instead of by scanning. The mobile device may communicate wirelessly with the point of sale equipment.

Process of Applying a Mobile Device to Coupon Transactions

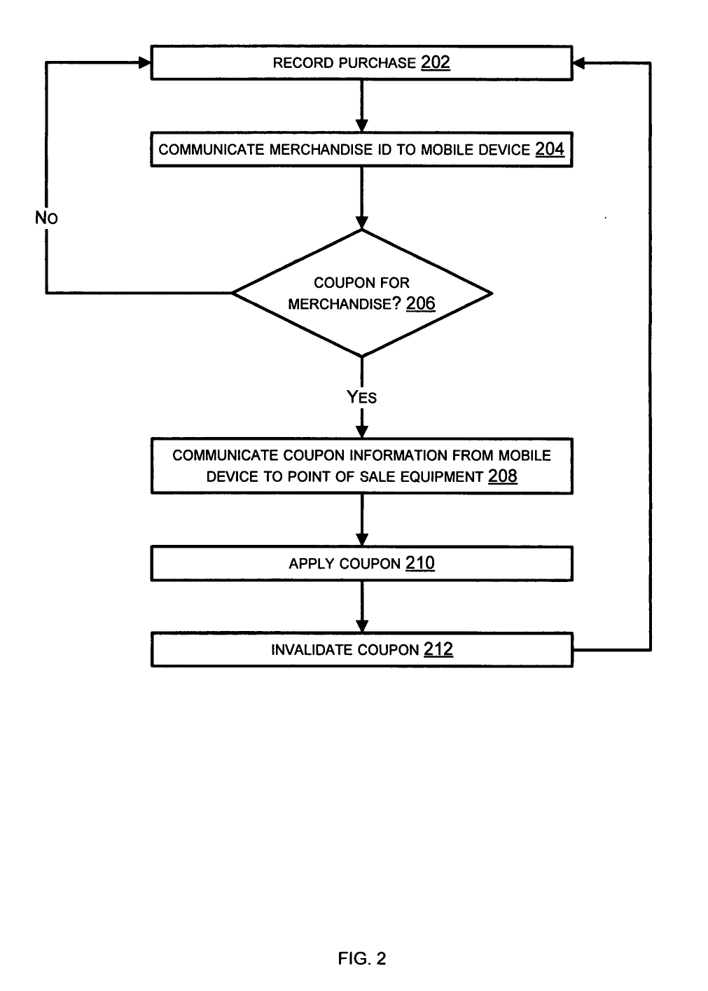

FIG. 2 is a flow chart of an embodiment of a process of applying a mobile device to coupon transactions.

Coupon Identification

The mobile device identifies one or more coupons to point of sale equipment to facilitate the sale of merchandise, and affects the coupon's value as a result of using the coupon in the sale of merchandise (either directly, or via the point of sale equipment as a result of the facilitated transaction).

One or more of the mobile device or point of sale equipment may identify the merchandise to the mobile device, and the mobile device may locate applicable stored coupon information.

The mobile device may provide coupon information to a user of the mobile device and provide for selection of the applicable coupon information by the user.

The mobile device may identify the merchandise and locate one or more suitable stored coupons. For example, the mobile device may perform photo recognition, scanning of one or more codes or symbols, or a combination thereof, in order to identify the merchandise. The mobile device may receive information about the merchandise wirelessly, from the point of sale equipment, from the merchandise itself, or from another device/location. For example, the mobile device may receive information via one or more of cellular communications, RFID, Bluetooth, Buzzby, Wi-Fi, or Wi-Max.

The mobile device may receive the coupon identifications from a cellular network, and/or receive the coupon information and/or merchandise identification from a local wireless network.

Identifying Proximity to a Retail Establishment

The mobile device may identify proximity and/or inclusion within a retail establishment in various fashions. This may facilitate the identification of applicable coupons.

The mobile device may apply wireless location recognition capability, such as one or more of GPS or cellular location technology, to identify its location. The mobile device may apply photo recognition to identify one or more brand names, trademarks, or service marks proximate to its location. The mobile device may apply scanning technology to identify one or more symbols or codes proximate to its location. The mobile device may receive a short-range wireless indication of the identity of the retail establishment from equipment within or proximate to the retail establishment. The mobile device may apply user input to identify proximity and/or inclusion within the retain establishment.

Coupon Presentation

The mobile device may provide a visual representation of coupon information to the point of sale equipment. This may involve the mobile device presenting an image of at least part of one or more coupons as they would appear in paper form. This may involve the mobile device presenting one or more symbols or barcodes, or both, for scanning by the point of sale equipment. The mobile device may communicate coupon information to the point of sale equipment, and the point of sale equipment may display the visual representation of the coupon information.

The mobile device may facilitate the printing of the coupon information, for example by providing the information to a local printer at the point of sale.

The mobile device may provide a scanned visual image of the coupon information to the point of sale equipment.

Affecting Coupon Value

One or more of the mobile device or the point of sale equipment may invalidate the coupon or otherwise affect the coupon's value once applied. For example, one or more of the mobile device or the point of sale equipment may debit value from the coupon.

Those having skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. A method comprising:
a mobile device identifying one or more coupons to point of sale equipment to facilitate the sale of merchandise; and
affecting the coupon's value as a result of using the coupon in the sale of merchandise.

2. The method of claim 1, wherein the mobile device identifying one or more coupons to point of sale equipment to facilitate the sale of merchandise further comprises:
the mobile device providing a visual representation of coupon information to the point of sale equipment.

3. The method of claim 2, wherein the mobile device providing a visual representation of coupon information to the point of sale equipment further comprises:
the mobile device presenting an image of at least part of one or more coupons as they would appear in paper form.

4. The method of claim 2, wherein the mobile device providing a visual representation of coupon information to the point of sale equipment further comprises:
the mobile device presenting one or more symbols or barcodes, or both, for scanning by the point of sale equipment.

5. The method of claim 2, wherein the mobile device providing a visual representation of coupon information to the point of sale equipment further comprises:
the mobile device communicating coupon information to the point of sale equipment, and the point of sale equipment displaying the visual representation of the coupon information.

6. The method of claim 2, wherein the mobile device providing a visual representation of coupon information to the point of sale equipment further comprises:
the mobile device facilitating the printing of the coupon information.

7. The method of claim 2, wherein the mobile device providing a visual representation of coupon information to the point of sale equipment further comprises:
the mobile device providing a scanned visual image of the coupon information to the point of sale equipment.

8. The method of claim 1, wherein affecting the coupon's value as a result of using the coupon in the sale of merchandise further comprises:
one or more of the mobile device or the point of sale equipment invalidating the coupon.

9. The method of claim 1, wherein affecting the coupon's value as a result of using the coupon in the sale of merchandise further comprises:
one or more of the mobile device or the point of sale equipment debiting value from the coupon.

10. The method of claim 1, wherein the mobile device identifying one or more coupons to point of sale equipment to facilitate the sale of merchandise further comprises:
the mobile device communicating wirelessly with the point of sale equipment.

11. The method of claim 1, wherein the mobile device identifying one or more coupons to point of sale equipment to facilitate the sale of merchandise further comprises:
the mobile device comprising one of a cell phone, personal digital assistant, camera, pager, media player, or other handheld device.

12. The method of claim 1, wherein the mobile device identifying one or more coupons to point of sale equipment to facilitate the sale of merchandise further comprises:
the mobile device comprising one of a watch, ring, medallion, jewelry, or other worn item.

13. The method of claim 1, wherein the mobile device identifying one or more coupons to point of sale equipment to facilitate the sale of merchandise further comprises:
one or more of the mobile device or point of sale equipment identifying the merchandise to the mobile device, and the mobile device locating applicable stored coupon information.

14. The method of claim 1, wherein the mobile device identifying one or more coupons to point of sale equipment to facilitate the sale of merchandise further comprises:
the mobile device providing coupon information to a user of the mobile device and providing for selection by the user.

15. The method of claim 1, further comprising:
the mobile device identifying proximity and/or inclusion within a retail establishment.

16. The method of claim 15, wherein the mobile device identifying proximity and/or inclusion within a retail establishment further comprises:
the mobile device applying wireless location recognition capability.

17. The method of claim 16, wherein the mobile device applying wireless location recognition capability further comprises:
the mobile device applying one or more of GPS or cellular location technology.

18. The method of claim 15, wherein the mobile device identifying proximity and/or inclusion within a retail establishment further comprises:
the mobile device applying photo recognition to identify one or more brand names, trademarks, or service marks.

19. The method of claim 18, wherein the mobile device applying photo recognition to identify one or more further comprises:
the mobile device applying scanning technology to identify one or more symbols or codes.

20. The method of claim 15, wherein the mobile device identifying proximity and/or inclusion within a retail establishment further comprises:
the mobile device receiving a short-range wireless indication of the identity of the retail establishment from equipment within or proximate to the retail establishment.

21. The method of claim 15, wherein the mobile device identifying proximity and/or inclusion within a retail establishment further comprises:
the mobile device applying user input to identify the proximity and/or inclusion within the retain establishment.

22. The method of claim 1, further comprising:
the mobile device identifying the merchandise and locating one or more suitable stored coupons.

23. The method of claim 22, wherein the mobile device identifying the merchandise and locating one or more suitable stored coupons further comprises:
the mobile device performing photo recognition, scanning of one or more codes or symbols, or a combination thereof, in order to identify the merchandise.

24. The method of claim 22, wherein the mobile device identifying the merchandise and locating one or more suitable stored coupons further comprises:
the mobile device receiving information about the merchandise wirelessly.

25. The method of claim 24, wherein the mobile device receiving information about the merchandise wirelessly further comprises:
the mobile device receiving information via one or more of cellular communications, RFID, Bluetooth, Buzzby, Wi-Fi, or Wi-Max.

26. The method of claim 22, wherein the mobile device identifying the merchandise and locating one or more suitable stored coupons further comprises:
the mobile device communicating wirelessly with the point of sale equipment to identify the merchandise.

27. The method of claim 22, wherein the mobile device identifying the merchandise and locating one or more suitable stored coupons further comprises:
the mobile device receiving the coupon identifications from a cellular network.

28. The method of claim 22, wherein the mobile device identifying the merchandise and locating one or more suitable stored coupons further comprises:
the mobile device receiving the coupon information and/or merchandise identification from a local wireless network.
